(19) United States
(12) Patent Application Publication
(10) Pub. No.: US 2021/0392033 A1
(43) Pub. Date: Dec. 16, 2021

(54) Systems and Methods for Managing Failed Packet Transmissions using a Smart Retransmission Scheme with Hierarchical Packet Analysis

(71) Applicant: Plantronics, Inc., Santa Cruz, CA (US)

(72) Inventor: Jacobus Cornelis HAARTSEN, Rolde (NL)

(73) Assignee: Plantronics, Inc., Santa Cruz, CA (US)

(21) Appl. No.: 16/901,251

(22) Filed: Jun. 15, 2020

(51) Int. Cl. H04L 12/24; H04L 12/26

(52) U.S. Cl. CPC H04L 41/0654; H04W 84/12; H04L 43/0847

(57) ABSTRACT

Systems and methods are provided for identifying the true content of a data packet wirelessly transmitted and retransmitted from a first device to a second device. The second device receives an original transmission of the data packet (first packet instance), followed by first and second retransmissions of the data packet (second and third packet instances), thus defining a group of three received packet instances, each including erroneous data. The second device may execute a hierarchical packet analysis algorithm to determine the true content of the transmitted data packet, which includes (a) testing selected pairs of the three packet instances to attempt to determine the true content of the transmitted data packet; and (b) if the pair-wise analysis fails, analyzing the first, second, and third packet instances collectively (triplet analysis) to attempt to determine the true content of the transmitted data packet.

### TECHNICAL FIELD

The present invention relates to the field of wireless communications, and more particularly, to systems and methods for managing failed packet transmissions (e.g., in a Bluetooth or other packet-based wireless communications environment) using a smart retransmission scheme and a hierarchical packet analysis, to improve performance, e.g., to improve user density and/or wireless range.

### BACKGROUND

Enterprise wireless communications environments, e.g., call centers, often use Bluetooth Classic, Bluetooth derivatives such as Bluetooth Low Energy (BLE), Digital European Cordless Telecommunications (DECT), and other packet-based radio systems for wireless communications. In such environments, user density and effective wireless range for wireless communications (e.g., voice, streaming music, etc.) are important factors defining the capability or quality of the respective environment.

User density relates to the number of active users in a restricted area that experience an acceptable service level, e.g., according to defined performance standards. User density typically depends on several parameters such as the traffic per load link, the number carriers to hop over, the link capacity needed per user, and the robustness of the link protocol. The effective range of a wireless communications system typically depends on noise conditions in the receiver and the implemented modulation scheme. For example, wide-band, high-rate modulation schemes are typically more susceptible to noise and result in a lower range.

Bluetooth uses a frequency-hopping and time-slotted protocol. In a Bluetooth system, voice is compressed and sent in a series of short packets to the receiver. A packet may be interfered by packets from other Bluetooth transmitters, or by signals from other transmitters in the 2.4 GHz ISM band used by Bluetooth. A major source of interference in which band is WiFi technology based on the IEEE 802.11 standard. A packet reception may be interfered by another packet when there is a collision in time and in frequency. Whether a packet is lost (e.g., received erroneously at the intended recipient) depends on (1) the strength of the interference power with respect to the strength of the intended received power, (2) whether the packets (partly) overlap in time, and (3) whether the packets make use of the same (or near-adjacent) carrier frequency. An erroneously received packet (e.g., where at least one bit in the received bit pattern is erroneous) is referred to herein as a “failed packet,” whereas a received packet containing the true content is referred to herein a “successful packet.” The “true content” of a packet refers to the content (i.e., bit pattern) of the packet transmitted by the transmitting device for receipt by the recipient.

The quality of a Bluetooth connection (or other packet-based radio connection) may be defined by an error rate experienced at the wireless receiver, referred to herein as the Data Error Rate (DER), which may define, for example, a Bit Error Rate (BER), a Packet Error Rate (PER), or a Frame Error Rate (FER) experienced at the Bluetooth receiver.

Several methods have been investigated to improve user density in Bluetooth environments, for example by reducing the transmitted interference or by improving the robustness of the receiver, e.g., to reduce the impact of packet collisions, and thus failed packets, at the receiver. Reduced interference can be achieved by lowering the duty cycle of the transmission, for example by using lower-rate audio codecs or by applying Discontinuous Transmission (DTX). The robustness of the receiver can, for example, be achieved by sharper filtering to suppress interferers operating on adjacent carriers, or by applying more retransmissions, as discussed below. Some improvement measures require hardware changes (typically carried out by the chip manufacturers), others can be implemented with software changes only.

One particular technique for reducing transmission errors and thus increasing user density involves automatically retransmitting failed packets. For example, some existing Bluetooth systems are configured to perform one or more retransmission of each failed packet to reduce transmission errors.

FIG. 1 illustrates a timing diagram of a mono voice link (eSCO) according to a standard Bluetooth protocol that implements automatic retransmission of failed packets. Each Bluetooth receiver (e.g., master and slave device) analyzes each received packet using a Cyclic Redundancy Check (“CRC check”) to determine whether the received packet contains the true content (i.e., a successful packet) or contains erroneous data (i.e., a failed packet). If the CRC check passes, the receiver notifies the transmitter of the passed CRC check, and the transmitter does not retransmit the packet. However, if the CRC check fails, the receiver notifies the transmitter of the failed CRC check; if the transmitter does not receive a notification of the CRC check within a certain time period, this may automatically be interpreted as a failed CRC. A failed CRC check prompts to the transmitter to retransmit the failed packet until either (a) the receiver notifies the transmitter of a passed CRC check after a particular retransmission of the packet (indicating a successful packet) or (b) the transmitter reaches a predefined maximum number of retransmissions.

Thus, with reference to the mono voice link shown in FIG. 1, a master device (“master”) performs an initial transmission of a first voice packet to a slave device (“slave”), followed the slave performing an initial transmission of a second voice packet to the master, along with a result of a CRC check performed by the slave indicating whether the first voice packet from the master was received at the slave as a successful packet or as a failed packet. If the CRC check result indicates a failed CRC check, the master initiates a first retransmission of the first voice packet, along with a result of a CRC check performed by the master indicating whether the second voice packet from the slave was a successful packet or a failed packet. Retransmissions by the master and/or slave may continue until the master and slave each receive a successful packet from the other device (i.e., a packet including the true content), or until a maximum number of retransmissions is reached.

FIG. 1 also indicates the carrier frequency fx of each respective transmission. As indicated, each retransmission may be performed on a different carrier frequency. This pattern is repeated every 7.5 ms (referred to as a connection interval), each time using different carrier frequencies.

In the Bluetooth standard, the maximum number of retransmissions in each connection interval by each device (master and slave) can be negotiated for each link via a link manager (LM) protocol during a link setup. By default, the maximum number of retransmissions is typically set at two, such that any particular packet can be sent up to three times (original transmission plus up to two retransmissions). In some configurations, the maximum retransmission number is increased to three, which has been found to increase the allowable user density by about a factor of 1.4x.

As discussed above, each Bluetooth receiver analyzes each received packet using a CRC check to determine whether the received packet contains the true content of the transmitted packet (i.e., a successful packet) or contains erroneous data (i.e., a failed packet). When a receiver receives an initial transmission of a packet, the receiver analyzes the packet using a CRC check, as discussed above. If the CRC check fails, and the receiver prompts the sender to retransmit the failed packet, the receiver may then utilize one of multiple different techniques to analyze the received retransmission (or multiple retransmissions) of the failed packet.

For example, in some existing systems, the receiver analyzes each retransmission of a failed packet individually to determine whether the respective retransmission contains the true content (successful packet) or erroneous data (failed packet). When each retransmitted packet is received, the previously received transmission/retransmission of the packet is discarded. Thus, each retransmission is independently analyzed (e.g., by a CRC check of the retransmitted packet) without considering previous transmissions/retransmissions of the packet. This retransmission scheme is referred to as “dumb packet retransmission.”

FIG. 2 illustrates a graph indicating wireless range performance in a conventional system implementing a “dumb packet retransmission” scheme as described above. In particular, the graph illustrates residual FER versus carrier-to-noise ratio (C/N) for a defined number of packet retransmissions implemented by the system. As shown, for a specified FER (e.g., 1%, or 10⁻²), increasing the number of packet retransmissions decreases the C/N ratio needed to achieve the specified FER, and thus increases the wireless range that achieves the specified FER.

Other systems implement a “smart packet retransmission” scheme in which the receiver of a failed packet analyzes each received retransmission of the failed packet in combination (collectively) with previously received transmissions/retransmissions of the failed packet (referred to herein as multiple “packet instances”) to attempt to identify the true content of the failed packet. Most failed packets contain only one or a few error bits, and the error pattern often changes from packet to packet, i.e., the information in multiple packet retransmissions (after a failed packet) is correlated but the errors are not. In a smart packet retransmission scheme, the respective bit patterns of multiple packet instances are compared to identify positions in the bit pattern that include differing bits, which are identified as error positions. Once the error positions in the bit pattern are identified, a set of test bit patterns is generated that includes all possible bit combinations of the identified error positions, and a CRC check is performed on each test bit pattern until either (a) the CRC check passes for a particular test bit pattern, which bit pattern is thus deemed as the true content of the packet, or (b) the maximum number of retransmissions (as defined for the relevant Bluetooth configuration) is reached.

Smart packet retransmission schemes generally increase both user density and range, e.g., by improving receiver sensitivity, as compared with dumb packet retransmission schemes as discussed above. However, not only dumb packet retransmission scheme, but also existing smart packet retransmission schemes have limited effectiveness, e.g., based on the limitations of the respective hardware (e.g., processing speed) utilized by the respective wireless communications devices (e.g., the master and slave devices discussed). For example, it is known that as the number of erroneous bit positions (referred to herein by the variable “M”) being analyzed increases, the effectiveness of smart packet retransmission schemes decreases, due to inherent hardware-related processing limitations. Existing smart packet retransmission schemes typically employ inefficient algorithms, especially for handling packets containing significant errors (e.g., M>5, M>10, or M>20), which limits the resulting user density or effective wireless range in the respective environment.

Thus, an object exists for smart packet retransmission schemes having improved efficiency, to thereby increase user density and/or wireless range in a wireless packet-based communications environment employing a packet retransmission protocol, e.g., Bluetooth, Bluetooth Classic, Bluetooth derivatives such as Bluetooth Low Energy (BLE), or Digital European Cordless Telecommunications (DECT) environments.

### SUMMARY

The following summary of the present invention is provided to facilitate an understanding of some of the innovative features unique to the present invention and is not intended to be a full description. A full appreciation of the various aspects of the invention can be gained by taking the entire specification, claims, drawings, and abstract as a whole.

The above object and other objects are solved by the invention as defined in the independent claims. The dependent claims and the following specification discuss various embodiments.

In one aspect, a method is provided for identifying the true content of a transmitted data packet wirelessly transmitted by a first device to a second device. The second device receives a first packet instance comprising a received version of the transmitted data packet, followed by a second packet instance comprising a received version of a first retransmission of the data packet transmitted by the first device, followed by a third packet instance comprising a received version of a second retransmission of the data packet transmitted by the first device. The first, second, and third packet instances received at the second device define a packet instance group. Each packet instance in the packet instance group includes erroneous data differing from the true content in at least one bit position. The second device executes a hierarchical packet analysis algorithm to attempt to determine the true content of the transmitted data packet. The hierarchical packet analysis includes (a) analyzing individual packet instances, e.g., upon the receipt of each respective packet instance at the second device, to attempt to determine the true content of the transmitted data packet (b) if the analysis of the individual packet instances fails, analyzing pairs of packet instances selected from the packet instance group to attempt to determine the true content of the transmitted data packet, and (c) if the analysis of the pairs of packet instances fails, analyzing the first, second, and third packet instances collectively to attempt to determine the true content of the transmitted data packet.

In one aspect, the second stage of the hierarchical packet analysis algorithm, i.e., analyzing pairs of packet instances to attempt to determine the true content of the transmitted data packet, includes (i) selecting and analyzing a pair of packet instances to attempt to determine the true content of the transmitted data packet, and (ii) repeating the selecting and analyzing step for each pair of packet instances in the packet instance group until either (a) the true content of the transmitted data packet is determined or (b) all pairs of packet instances in the packet instance group have been analyzed.

One basic idea of the invention relates to the use of a staged, or “hierarchical” analysis of multiple instances of a failed packet (e.g., an original failed transmission of a packet plus at least two retransmissions of the failed packet) to determine the true content of the failed packet in a wireless packet-based communications environment, e.g., Bluetooth environment. The hierarchical packet analysis involves first analyzing individual packet instances; then, if the individual packet analysis fails to determine the true content, analyzing pairs of the packet instances (as opposed to analyzing all packet instances collectively); then, if the pair-wise analysis fails to determine the true packet content, analyzing triples of the packet instances; then (if there are more than three packet instances) analyzing foursomes of the packet instances, etc. The inventor has determined that this hierarchical packet analysis is more computationally efficient than existing techniques, thereby increasing user density and wireless range in the relevant communications environment.

In another aspect, a system is provided for identifying the true content of a transmitted data packet transmitted by a first device to a second device. The system includes a hierarchical packet analysis algorithm stored in non-transitory computer readable memory, and a computer processor coupled to the non-transitory computer readable memory. The computer processor is configured to receive a first packet instance comprising a received version of the transmitted data packet, followed by a second packet instance comprising a received version of a first retransmission of the data packet transmitted by the first device, followed by a third packet instance comprising a received version of a second retransmission of the data packet transmitted by the first device. The first, second, and third packet instances received at the computer processor define a packet instance group, and wherein each packet instance in the packet instance group includes erroneous data differing from the true content in at least one bit position. The computer processor is further configured to execute the hierarchical packet analysis to determine the true content of the transmitted data packet, which includes (a) analyzing individual packet instances to attempt to determine the true content of the transmitted data packet, (b) if the analysis of the individual packet instances fails, analyzing pairs of packet instances selected from the packet instance group to attempt to determine the true content of the transmitted data packet, and (c) if the analysis of the pairs of packet instances fails, analyzing the first, second, and third packet instances collectively to attempt to determine the true content of the transmitted data packet.

In another aspect, a system includes a first device configured to wirelessly transmit and retransmit a data packet for receipt by a second device. The second device is configured to receive a first packet instance comprising a received version of an original transmission of the data packet by the first device, notify the first device that the first packet instance includes erroneous data, receive a second packet instance comprising a received version of a first retransmission of the data packet by the first device, notify the first device that the second packet instance includes erroneous data, and receive a third packet instance comprising a received version of a second retransmission of the data packet by the first device. The first, second, and third packet instances received at the second device define a packet instance group, and each packet instance in the packet instance group includes erroneous data differing from a true content of the data packet in at least one bit position. The second device is further configured to execute a hierarchical packet analysis to determine the true content of the data packet, including (a) analyzing pairs of packet instances selected from the packet instance group to attempt to determine the true content of the data packet, and (b) if the analysis of the pairs of packet instances fails to determine the true content of the data packet, analyzing the first, second, and third packet instances collectively to attempt to determine the true content of the data packet.

The systems and methods disclosed herein, including the disclosed hierarchical packet analysis, may be implemented with any packet-based communications protocol that performs packet retransmissions, e.g., automatic repeat request (ARQ) functionality, for Bluetooth Classic, Bluetooth derivatives such as Bluetooth Low Energy (BLE), Digital European Cordless Telecommunications (DECT), and other packet-based radio systems. In addition, the disclosed hierarchical packet analysis may be utilized for both voice and streaming (e.g., music) communication links, including both single-direction and bi-directional links.

The details of one or more embodiments are set forth in the accompanying drawings and the description below. Other features will be apparent from the description, drawings, and from the claims.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a timing diagram of a mono voice link according to a standard Bluetooth protocol that implements automatic retransmission of failed packets;

FIG. 2 illustrates a graph indicating wireless range performance in a conventional system implementing a “dumb packet retransmission” scheme;

FIG. 3 illustrates an example execution of a hierarchical packet analysis algorithm after a single retransmission of a failed packet, in a packet-based wireless communication system that uses a smart retransmission scheme;

FIG. 4 illustrates a graph indicating test data of wireless range performance in a system implementing the hierarchical packet analysis algorithm shown in FIG. 3, after a single retransmission of a failed packet;

FIG. 5 illustrates an example execution of a hierarchical packet analysis algorithm after two retransmissions of a failed packet, in a packet-based wireless communication system that uses a smart retransmission scheme allowing for two (or more) retransmissions, according to one embodiment of the invention;

FIG. 6 illustrates a graph indicating test data of wireless range performance in a system implementing the hierarchical packet analysis algorithm shown in FIG. 5, after two retransmissions of a failed packet;

FIG. 7 illustrates a graph indicating the example test data from the hierarchical packet analysis algorithm after one retransmission and after two retransmissions;

FIG. 8 illustrates a graph showing (a) example test data from the hierarchical packet analysis algorithm shown in FIG. 5 after two retransmissions, and (b) example test data from a reference smart retransmission algorithm;

FIG. 9 illustrates a graph showing data indicating carrier/noise ratio at 1% residual FER as a function of M value (maximum number of error bits) after two packet retransmissions, for (a) the disclosed hierarchical packet analysis algorithm and (b) the reference smart retransmission algorithm;

FIG. 10 illustrates an example execution of a hierarchical packet analysis algorithm after receiving a third retransmission of a failed packet, in a packet-based wireless communication system that uses a smart retransmission scheme allowing for three (or more) retransmissions, according to one embodiment of the invention;

FIG. 11 illustrates a table showing required C/N to achieve 1% residual FER, for a protocol allowing no packet retransmissions, one retransmission, two retransmissions, and three retransmissions, using (a) a conventional dumb retransmission scheme and (b) the disclosed the hierarchical packet analysis algorithm;

FIG. 12 illustrates a graph illustrating wireless range as a function of receiver sensitivity for the different cases shown in table 11 of FIG. 11;

FIG. 13 illustrates a table showing the effect of the disclosed hierarchical packet analysis on user density in an example Bluetooth Classic system;

FIG. 14 illustrates a majority voting algorithm for use with the disclosed hierarchical packet analysis algorithm, according to some embodiments of the invention;

FIG. 15 is a flowchart showing an example method for performing a hierarchical packet analysis for identifying the true content of a transmitted packet, according to some embodiments of the invention; and

FIG. 16 illustrates an example system for performing a hierarchical packet analysis for identifying the true content of a transmitted packet, according to some embodiments of the invention.

### DETAILED DESCRIPTION

Specific embodiments of the invention are here described in detail, below. In the following description of embodiments of the invention, the specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In the following explanation of the present invention according to the embodiments described, the terms “connected to” or “connected with” are used to indicate a data and/or audio (signal) connection between at least two components, devices, units, processors, or modules. Such a connection may be direct between the respective components, devices, units, processors, or modules; or indirect, i.e., over intermediate components, devices, units, processors, or modules. The connection may be permanent or temporary; wireless or conductor based.

For example, a wireless data connection (e.g., communicating audio and/or streaming music) may be provided over direct connection, a bus, or over a network connection, such as a WAN (wide area network), LAN (local area network), PAN (personal area network), BAN (body area network) comprising, e.g., the Internet, Ethernet networks, cellular networks, such as LTE, Bluetooth (classic, smart, or low energy) networks, DECT networks, ZigBee networks, and/or Wi-Fi networks using a corresponding suitable communications protocol. In some embodiments, a USB connection, a Bluetooth network connection and/or a DECT connection is used to transmit audio and/or data.

In the following description, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between like-named elements. For example, a first element is distinct from a second element, and the first element may encompass more than one element and succeed (or precede) the second element in an ordering of elements.

As discussed above, a need exists for increasing user density and wireless range in wireless packet-based communications environments, e.g., call centers or other environments including multiple wireless users using Bluetooth or other packet-based communications protocols. In particular, in environments that implement a packet retransmission protocol, e.g., most Bluetooth environments, there is a need for improved smart packet retransmission schemes having improved efficiency, to thereby increase user density and wireless range. The present invention provides systems and methods that address this need, providing an improved smart packet retransmission scheme that allows for increased user density and wireless range.

In one aspect, a method is provided for identifying the true content of a data packet wirelessly transmitted by a first device to a second device (“transmitted data packet”), for example first and second Bluetooth devices. The second device receives a first packet instance comprising a received version of the transmitted data packet, followed by a second packet instance comprising a received version of a first retransmission of the data packet transmitted by the first device, followed by a third packet instance comprising a received version of a second retransmission of the data packet transmitted by the first device. The first, second, and third packet instances received at the second device define a packet instance group. Each packet instance in the packet instance group includes erroneous data differing from the true content in at least one bit position. The second device executes a hierarchical packet analysis algorithm to attempt to determine the true content of the transmitted data packet. The hierarchical packet analysis involves (a) analyzing the packet instances individually, upon receiving each successive packet instance (referred to herein as a “single packet analysis”), (b) if the single packet analysis fails to determine the true content of the transmitted data packet, analyzing pairs of packet instances selected from the packet instance group to attempt to determine the true content of the transmitted data packet (referred to herein as a “pair-wise packet analysis”), and (c) if the pair-wise packet analysis fails to determine the true content of the transmitted data packet, analyzing the first, second, and third packet instances collectively to attempt to determine the true content of the transmitted data packet (referred to herein as a “triplet packet analysis”). The hierarchical packet analysis may terminate as soon as the true content of the transmitted data packet is determined, e.g., during the single packet analysis, the pair-wise packet analysis, or triplet packet analysis.

In some embodiments, the pair-wise packet analysis may include (a) selecting and analyzing a pair of packet instances to attempt to determine the true content of the transmitted data packet, and repeating the selecting and analyzing step for each pair of packet instances in the packet instance group until either (a) the true content of the transmitted data packet is determined or (b) all pairs of packet instances in the packet instance group have been analyzed.

In some embodiments, the step of selecting and analyzing a pair of packet instances may include (a) comparing the selected pair of packet instances to identify a set of error bit positions in which the selected pair of packet instances include different data from each other; (b) generating a set of test bit patterns based on the set of error bit positions identified from the comparison of the selected pair of packet instances; and (c) analyzing each test bit pattern to determine whether the test bit pattern contains the true content of the transmitted data packet.

In some embodiments, the step of generating a set of test bit patterns includes identifying a set of bit value combinations for the set of error bit positions identified from the comparison of the selected pair of packet instances, and generating a test bit pattern for each identified bit value combination. In some embodiments, the step of wherein analyzing each test bit pattern comprises performing a Cyclic Redundancy Check (CRC) on each test bit pattern.

In some embodiments, the step of analyzing the first, second, and third packet instances collectively to attempt to determine the true content of the transmitted data packet includes (a) comparing the first, second, and third packet instances collectively to identify a set of error bit positions in which at least two of the packet instances include different data from each other; (b) generating a set of test bit patterns based on the set of error bit positions identified from the collective comparison of the first, second, and third packet instances; and (c) analyzing each test bit pattern to determine whether the test bit pattern contains the true content of the transmitted data packet. In some embodiments, each test bit pattern is analyzed using a Cyclic Redundancy Check (CRC).

In some embodiments, the step of generating a set of test bit patterns includes identifying a set of bit value combinations for the set of error bit positions identified from the collective comparison of the first, second, and third packet instances, and generating a test bit pattern for each identified bit value combination.

In some embodiments, the method further includes, after receiving the first packet instance at the second device, (a) determining, by the second device, that the received first packet instance contains erroneous data, and (b) transmitting, from the second device to the first device, a notification that the received first packet instance contains erroneous data.

In some embodiments, the data packet is transmitted and retransmitted according to the Bluetooth protocol.

In some embodiments, the first, second, and third packet instances are received at the second device via a Bluetooth link or a Digital Enhanced Cordless Telecommunications (DECT) link.

By performing a hierarchical packet analysis as discussed above, at least in some instances the true content of a failed packet is discovered during the pair-wire packet analysis, which avoids the need to perform the much more computationally-intensive triplet packet analysis.

In environments that allow for up to three retransmissions of a failed packet, the hierarchical packet analysis may involve (a) a single packet analysis in which packet instances are analyzed individually, followed by (b) a pair-wise analysis in which each pair of packet instances is analyzed separately, followed by (c) a triplet packet analysis in which each set of three packet instances is analyzed separately, followed by (d) a foursome packet analysis in which all four packet instances (i.e., the original failed packet plus all three retransmissions of the failed packet) are analyzed collectively.

In environments that allow for more than three retransmissions of a failed packet, the hierarchical packet analysis may involve (a) a single packet analysis, followed by (b) a pair-wise analysis, followed by (c) a triplet packet analysis, followed by (d) a foursome packet analysis, followed by (e) a fivesome packet analysis, and so on, until a final step in which all packet instances are analyzed collectively.

In each implementation, the hierarchical packet analysis, at least in some instances, may discover the true content of a failed packet during a particular stage of the analysis (e.g., during a pair-wise analysis stage or a triplet packet analysis stage) and avoid the need to perform further stages of the analysis that are more computationally-intensive.

Thus, a smart retransmission scheme that employs the inventive hierarchical packet analysis disclosed herein may reduce (on average) the processing time or resources needed to identify the true content of failed packets. As a result, the relevant system (e.g., hardware) for performing such packet analysis may be able to analyze, on average, a greater number of error-containing bit positions within the permitted or available analysis time defined by the relevant communications protocol and/or the memory size, power consumption, or other limitation of the system performing the packet analysis, as compared with conventional techniques for identifying the true content of failed packets.

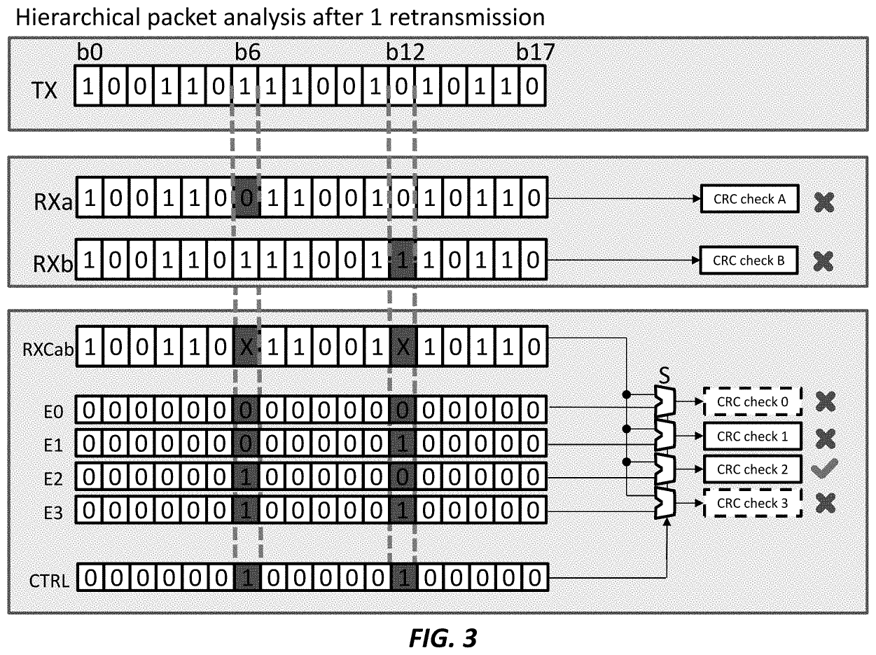

FIG. 3 illustrates an example execution of a hierarchical packet analysis algorithm after a single retransmission of a failed packet, in a packet-based wireless communication system that uses a smart retransmission scheme. A transmitting device transmits a data packet TX comprising an 18-bit bit pattern [b0, b1, . . . b17] for receipt by a receiving device (original transmission of packet TX).

The bit pattern of the original transmission of packet TX received at the receiving device is indicated at RXa (first packet instance). As shown in RXa, bit b6 is received in error, which causes a CRC check failure (CRC check A). CRC checks may be carried out in a Linear Feedback Shift Register (LFSR) where the received bits are clocked in and the final result must match a predetermined value (e.g., zero) to pass. In response to the failed CRC check A, the receiving device requests a retransmission of the failed packet, the transmitting device retransmits packet TX, and the retransmitted packet is received as bit pattern RXb (second packet instance). As shown in RXb, bit b12 is received in error, causing another CRC check failure (CRC check B).

According to the hierarchical packet analysis algorithm, after analyzing each packet instance RXa and RXb individually as discussed above, the receiving device then performs a “pair-wise packet analysis” of the received packet instances RXa and RXb to attempt to identify the true content of packet TX. First, the receiving device may compare bit patterns RXa and RXb to identify each bit position in which RXa and RXb include differing data, referred to herein as “error bit positions.” An error bit position refers to a bit position in which at least two packet instances contain different data; thus, for each particular packet instance, the data in an error bit position may be erroneous or correct, with respect to the true content of packet TX. The error bit positions b6 and b12 are indicated by an “X” in the combined bit pattern RXCab shown in FIG. 3, and collectively referred to as a set of error bit positions.

The receiving device then generates a set of test bit patterns based on the set of error bit positions. The set of test bit patterns may capture all possible bit combinations for the set of error bit positions, referred to as “error bit combinations,” minus any bit combinations that have already been tested (CRC checked). For any set of error bit positions including N bit positions, there are 2^{N} different error bit combinations. However, two of these error bit combinations, namely RXa and RXb, have already been CRC checked and failed. Thus, for any set of error bit positions including N bit positions, there are 2^{N}-2 different test bit patterns to be tested.

In this example in which N=2, there are four different error bit combinations, indicated in FIG. 3 as E0-E3. However, two of these error bit combinations, E0 and E3, correspond with bit patterns RXa and RXb, and thus have already been CRC checked (and failed). Thus, the receiving device may generate and test (CRC check) two test bit patterns, indicated at E1 and E2. The receiving device than performs a CRC check of each test bit pattern (E1 and E2), until either (a) the CRC check passes for a particular test bit pattern, which is thus identified as the true content of packet TX, or (b) the CRC check fails for both test bit patterns (e.g., in the case of “double errors” present in RXa and RXb, as discussed below). This collective analysis of a pair of packet instances, in this case RXa and RXb, by testing all bit error combinations, is referred to herein as a “pair-wise packet analysis.”

In the illustrated embodiment, to generate each test bit pattern E1 and E2, the receiving device may utilize a switch gates S and a control word CTRL to replace only the bits in error bit positions (b6 and b12). In the illustrated example, the CRC check fails for test bit pattern E1 but passes for test bit pattern E2. Thus, the receiving device identifies test bit pattern E2 as the true content of the transmitted packet, and can thus avoid requesting another retransmission of packet TX by the transmitting device.

It should be noted that a “double error,” where a bit error occurs in the same bit position in both received packet instances RXa and RXb, will not be detected by the algorithm discussed above, as this error bit position will not be detected by the comparison of RXa and RXb. Thus, where RXa and RXb contain at least one double error, the CRC check will fail for test bit patterns, resulting in the receiving device requiring an additional retransmission of the packet TX (in implementations that allow for at least two retransmissions) or resulting in a residual frame error when no further retransmissions can be requested (e.g., in an implementation that allows for only one retransmission of a failed packet).

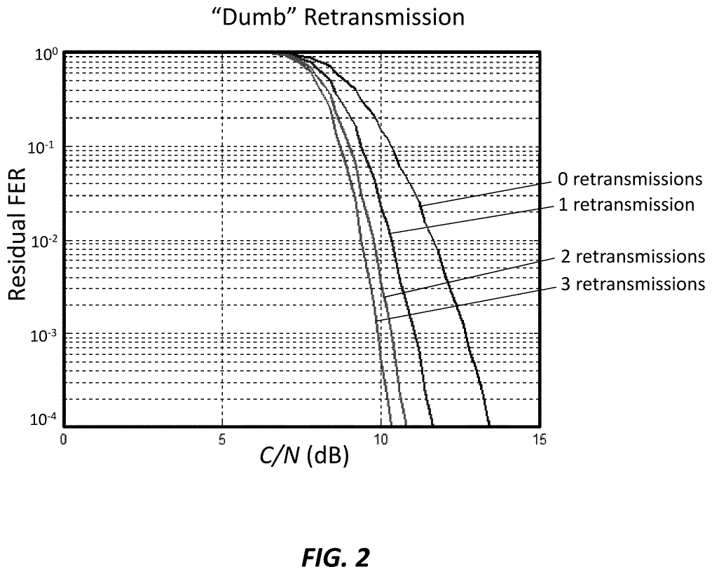

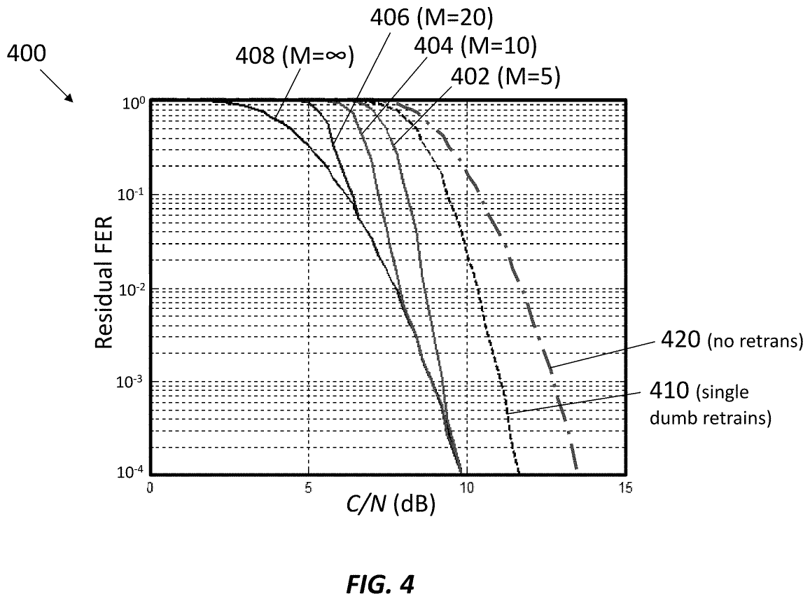

FIG. 4 illustrates a graph 400 indicating test data of wireless range performance in a system implementing the hierarchical packet analysis algorithm shown in FIG. 3, after a single retransmission of a failed packet. Graph 400 illustrates a number of different curves of residual FER versus carrier-to-noise ratio (C/N) for various different packet analysis protocols. In particular, graph 400 shows (a) four curves 402, 404, 406, and 408 implementing the hierarchical packet analysis algorithm shown in FIG. 3, for three different “M” values (discussed below); (b) a first reference curve 410 for a single retransmission using a conventional “dumb retransmission scheme,” which corresponds with the “1 retrans” curve shown in FIG. 2; and (c) a second reference curve 420 for a conventional implementation with no retransmissions, which corresponds with the “0 retrans” curve shown in FIG. 2.

As shown, the resulting performance (e.g., wireless range as represented by C/N value for a defined residual FER value) for the hierarchical packet analysis algorithm is substantially improved as compared with the reference implementations (single “dumb retransmission” scheme, and zero retransmission scheme). For example, at FER=1%, the hierarchical packet analysis algorithm (after a single transmission) provides an improvement of about 3 dB in C/N as compared with the single “dumb retransmission.”

As discussed above, the number of test bit patterns to be tested increases exponentially as a function of the number of error bit positions (N). For long packets with many errors, the number of test bit patterns can become unmanageable to process. Thus, tests were carried with the number of error bit positions capped at a maximum number M. Curves 402, 404, 406, and 408 indicate test results for M values of M=5 (curve 402), M=10 (curve 404), M=20 (curve 406), and M=infinity, i.e., no limit on the number of error bit position (curve 408).

As shown, increasing the maximum number of error bit positions (M) increases the system performance (e.g., increasing wireless range as represented by C/N value for a defined residual FER value), especially at higher FER values. However, because the number of test bit patterns increases exponentially with increasing bit errors, the number of error bits that can be effectively processed, for example within an allotted time defined by the relevant communications protocol, is typically limited by the hardware of the receiving device, e.g., defining the available computing power or speed for executing the hierarchical packet analysis algorithm. For example, the relevant communications protocol (e.g., relevant Bluetooth protocol) may specify a defined time period during which the receiving device must determine a meaningful response to send the transmitting device, including whether to request an additional retransmission.

The hierarchical packet analysis may also improve performance by reducing the traffic on the wireless link caused by retransmissions of failed packets. For example, as discussed above, in the example shown in FIG. 3, a second (and maybe third) retransmission of packet TX may be avoided by the hierarchical packet analysis that identifies the true content of packet TX after the first retransmission, e.g., as compared with a dumb retransmission scheme. The hierarchical packet analysis provides error correction at the receiver, obviating the need for additional retransmissions from the sender.

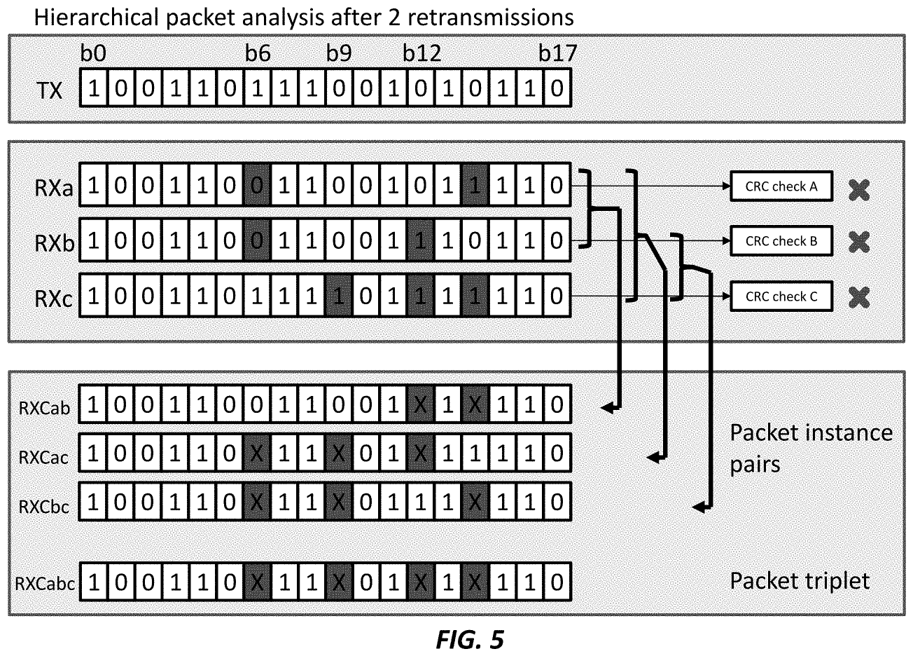

FIG. 5 illustrates an example execution of a hierarchical packet analysis algorithm after two retransmissions of a failed packet, in a packet-based wireless communication system that uses a smart retransmission scheme allowing for two (or more) retransmissions, according to one embodiment of the invention. For example, FIG. 5 may represent a continuation of the algorithm shown in FIG. 3, in a situation in which the algorithm fails to discover the true content of the transmitted packet TX after a single retransmission, for example (a) due to the presence of at least one “double error” in packet instances RXa and RXb, or (b) the number of testable error bit positions was capped according to the particular implementation and the correct test bit pattern (representing the true content of packet TX) was never tested due to the error bit position cap.

As shown, the transmitting device transmits data packet TX comprising an 18-bit bit pattern [b0, b1, . . . b17] for receipt by the receiving device (original transmission of packet TX). The receiving device receives the transmitted packet as bit pattern RXa (first packet instance). As shown in RXa, bit b6 is received in error, which causes a CRC check failure (CRC check A). In response, the receiving device requests a retransmission of the failed packet, the transmitting device retransmits packet TX, and this first retransmission is received as bit pattern RXb (second packet instance). As shown in RXb, bits b6 and b12 are received in error, causing another CRC check failure (CRC check B).

The receiving device then analyzes RXa and RXb collectively, e.g., according to the pair-wise packet analysis discussed above regrading FIG. 3. As discussed above, there are four different error bit combinations derivable from the two error bit positions b6 and b12, two of which correspond with RXa and RXb. Thus, the receiving device may generate a set of test bit patterns comprising the two error bit combinations that do not correspond with the RXa and RXb, as the bit patterns RXa and RXb have already been tested (both failing a CRC check). The receiving device may then perform a CRC check of each of two test bit patterns, e.g., as discussed above regarding FIG. 3. If either test bit pattern passes the CRC check, the passing bit pattern is identified as the true content of packet TX, and further retransmission(s) or analysis is avoided. Alternatively, if both test bit patterns fail the CRC check (e.g., in the case of “double errors” present in RXa and RXb), the receiving device requests a second retransmission of the failed packet TX from the transmitting device, which is received at the receiving device as bit pattern RXc (third packet instance).

According to the example hierarchical packet analysis algorithm shown in FIG. 5, the receiving device then analyzes the three packet instances RXa, RXb, and RXc in a staged, hierarchical manner. First, the receiving device performs a CRC check of RXc individually, which fails due to error bits b9 and b12 shown in FIG. 5. Second, the receiving device performs a pair-wise packet analysis of the three packet instances RXa, RXb, and RXc which pair-wise packet analysis is discussed below in detail). Third, if the pair-wise packet analysis fails to discover the true content of packet TX, the receiving device performs a collective analysis of the three packet instances RXa, RXb, and RXc.

For the pair-wise packet analysis of packet instances RXa, RXb, and RXc, each respective pair of packet instances in the group of RXa, RXb, and RXc may be compared to define a respective pair-wise bit pattern that specifies the respective error bit positions relevant to the respective pair of packet instances. For example, as shown in FIG. 5, (a) packet instances RXa and RXb may be compared to define a first pair-wise bit pattern RXCab including two error bit positions b12 and b14, each indicated by an “X” in RXCab; (b) packet instances RXa and RXc are compared to define a second pair-wise bit pattern RXCac including three error bit positions b6, b9, and b12, each indicated by an “X” in RXCac; and (c) packet instances RXb and RXc are compared to define a third pair-wise bit pattern RXCbc including three error bit positions b6, b9, and b14, each indicated by an “X” in RXCbc.

According to the example hierarchical packet analysis algorithm, the receiving device may perform a pair-wise packet analysis of bit patterns RXCab, RXCac, and RXCbc, except for bit patterns that have already been tested (CRC checked). In this example, the pair-wise bit patterns RXCab, RXCac, and RXCbc are each different than the packet instances RXa, RXb, and RXc and thus have not yet been analyzed and tested. Thus, the receiving device may perform a pair-wise packet analysis of each pair-wise bit pattern RXCab, RXCac, and RXCbc. For each bit pattern RXCab, RXCac, and RXCbc, the receiving device may identify all bit error combinations and generate and test corresponding bit test patterns (that have not already been tested) until either (a) the CRC check passes for a particular test bit pattern, which is identified as the true content of packet TX and avoids the need for further analysis and/or further retransmission(s) of packet TX, or (b) the CRC check fails for all test bit patterns, causing the receiving device to advance to the next stage of the hierarchical packet analysis algorithm, namely a triplet packet analysis of packet instances RXa, RXb, and RXc collectively. In some embodiments, the receiving device may analyze the pair-wise bit patterns RXCab, RXCac, and RXCbc in a particular order, based on defined rule(s). For example, the receiving device may analyze the pair-wise bit patterns in order based on the least number of error bit positions (i.e., the smallest number of X's); thus, in this example, the receiving device may analyze RXCab (two error bit positions), then RXCac (three error bit positions), and finally RXCbc (three error bit positions).

In this example, the pair-wise packet analysis of bit pattern RXCab may involve identifying 4 error bit combinations (based on two error bit positions (N=2), which provides 2^{N}=4 different error bit combinations), and generating 2 different test bit patterns from the 4 error bit combinations, as 2 of the 4 error bit combinations correspond with bit patterns RXa and RXb, which have already been tested. Then, the pair-wise packet analysis of bit pattern RXCac may involve identifying 8 error bit combinations (based on three error bit positions (N=3)), and generating 5 different test bit patterns from the 8 error bit combinations, as 3 of the 8 error bit combinations have already been tested, namely (a) bit pattern RXa (b) bit pattern RXc, and (c) the bit pattern with bit values of 0, 0, 0 at b6, b9, and b12, which was already tested during the analysis of RXCab. Finally, the pair-wise packet analysis of bit pattern RXCbc may involve identifying 8 error bit combinations (based on three error bit positions (N=3)), and generating 3 different test bit patterns from the 8 error bit combinations, as 5 of the 8 error bit combinations have already been tested during the preceding analysis and testing steps.

As discussed above, if the CRC check fails for all test bit patterns during the pair-wise packet analysis of bit patterns RXCab, RXCac and RXCbc, the hierarchical packet analysis algorithm may advance to the next stage, a triplet packet analysis of packet instances RXa, RXb, and RXc collectively. In the triplet analysis, the receiving device may (a) compare packet instances RXa, RXb, and RXc to define a triplet bit pattern RXCabc having a set of error bit positions in which RXa, RXb, and RXc include differing data at the same bit position, (b) identify all error bit combinations derivable from the set of error bit positions, (c) generate test bit patterns for each error bit combination that has not already been tested, and (d) perform a CRC check of each test bit pattern.

In the illustrated example, the triplet bit pattern RXCabc includes four error bit positions b6, b9, b12, and 14, each indicated by an “X” in RXCabc. The receiving device may then identify 16 error bit combinations derivable from the set of four error bit positions. The receiving device may generate test bit patterns for each of the 16 error bit combinations that has not already been tested during the analysis and testing of RXa, RXb, RXc, RXCab, RXCac, and RXCbc. In this case, three of the 16 error bit combinations have not been tested, and thus three test bit patterns are generated. Finally, the receiving device may perform a CRC check of each of the three test bit patterns to attempt to identify the true content of packet TX.

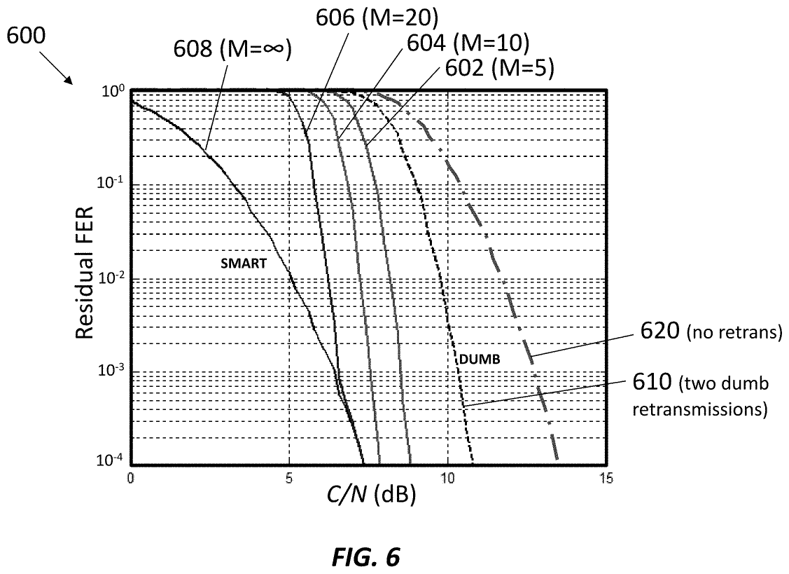

FIG. 6 illustrates a graph 600 indicating test data of wireless range performance in a system implementing the hierarchical packet analysis algorithm shown in FIG. 5, after two retransmissions of a failed packet. Graph 600 illustrates a number of different curves of residual FER versus carrier-to-noise ratio (C/N) for various different packet analysis protocols. Graph 600 is similar to graph 400 shown in FIG. 4, but showing results of the disclosed hierarchical packet analysis after two packet retransmissions rather than one. In particular, graph 600 shows (a) four curves 602, 604, 606, and 608 implementing the hierarchical packet analysis algorithm shown in FIG. 5, for three different “M” values (discussed above regarding FIG. 4); (b) a first reference curve 610 indicating the results after two retransmissions using a conventional “dumb” retransmission scheme, which corresponds with the “2 retrans” curve shown in FIG. 2; and (c) a second reference curve 420 for a conventional implementation with no retransmissions, which corresponds with the “0 retrans” curve shown in FIG. 2.

As shown by curves 602-608, the resulting performance (e.g., wireless range as represented by C/N value for a defined residual FER value) for the hierarchical packet analysis algorithm is substantially improved as compared with the reference schemes indicated at 610 and 620. For example, at FER=1%, the hierarchical packet analysis algorithm (after a single transmission) provides an improvement of about 5 dB in C/N as compared with two “dumb” retransmissions.

As discussed above, the number of test bit patterns to be tested increases exponentially as a function of the number of error bit positions (N). For long packets with many errors, the number of test bit patterns can become unmanageable to process. Thus, tests were carried with the number of error bit positions capped at a maximum number M. Curves 602, 604, 606, and 608 indicate test results for M values of M=5 (curve 602), M=10 (curve 604), M=20 (curve 606), and M=infinity, i.e., no limit on the number of error bit position (curve 608).

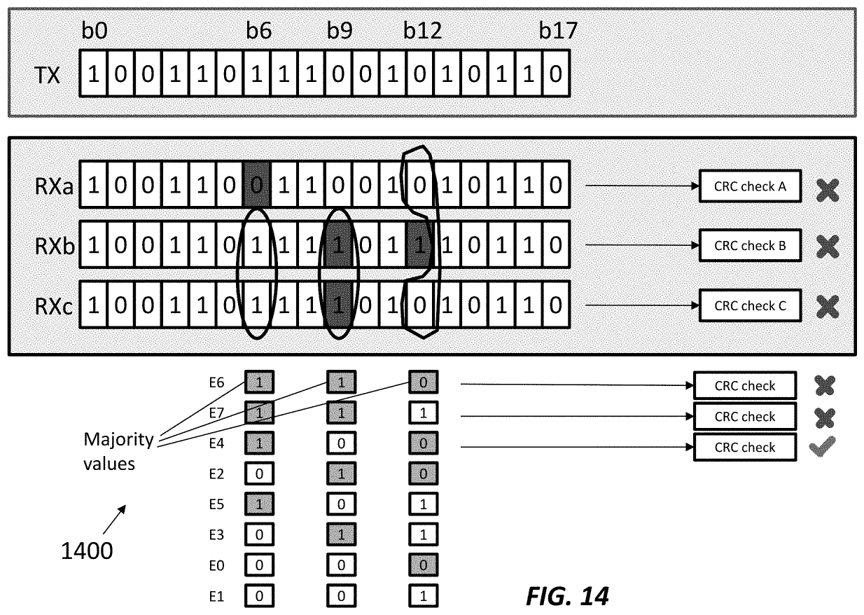

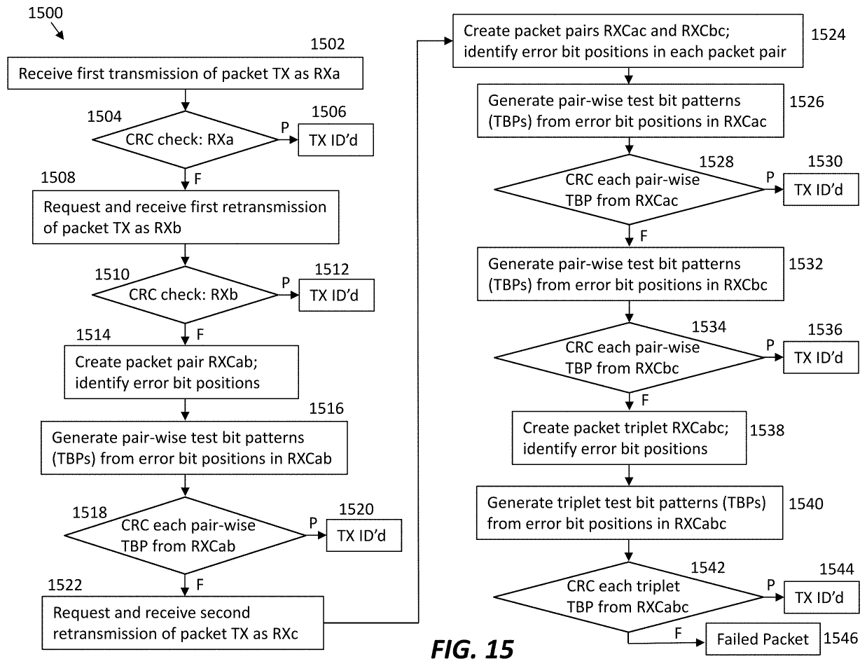

As discussed below with reference to the process flow shown in FIG. 15, in some embodiments a receiving device implementing a hierarchical packet analysis algorithm to identify the true content of received packets may implement a defined cap on the maximum number of error bit positions (M) that the device will attempt to analyze. As discussed below, different embodiments may utilize an error bit position cap (M) in different ways. For example, if the number of error bit positions to be analyzed by a receiving device exceeds a defined maximum number M, the receiving device may request an additional retransmission from the transmitter, or declare a packet failure if a defined maximum number of retransmissions has been reached. As another example, the receiving device may test 2^{M} test bit patterns before (if necessary) requesting a retransmission. The device may select the 2^{M} test bit patterns using any suitable rules, e.g., by majority voting such as described below with reference to FIG. 14.

As shown (and discussed above regarding FIG. 4), increasing the maximum number of error bit positions (M) increases the system performance (e.g., increasing wireless range), especially at higher FER values. However, because the number of test bit patterns increases exponentially with increasing bit errors, the number of error bits that can be effectively processed, for example within an allotted time defined by the relevant communications protocol, is typically limited by the hardware of the receiving device, e.g., defining the available computing power or speed for executing the hierarchical packet analysis algorithm. For example, the relevant communications protocol (e.g., relevant Bluetooth protocol) may specify a defined time period during which the receiving device must determine a meaningful response to send the transmitting device, including whether to request an additional retransmission.

As discussed above, the hierarchical packet analysis may also improve performance by reducing the traffic on the wireless link caused by retransmissions of failed packets. For example, as discussed above, in the example shown in FIG. 5, a third (or more) retransmission of packet TX may be avoided by the hierarchical packet analysis that identifies the true content of packet TX after the second retransmission, e.g., as compared with a dumb retransmission scheme. The hierarchical packet analysis provides error correction at the receiver, obviating the need for additional retransmissions from the sender.

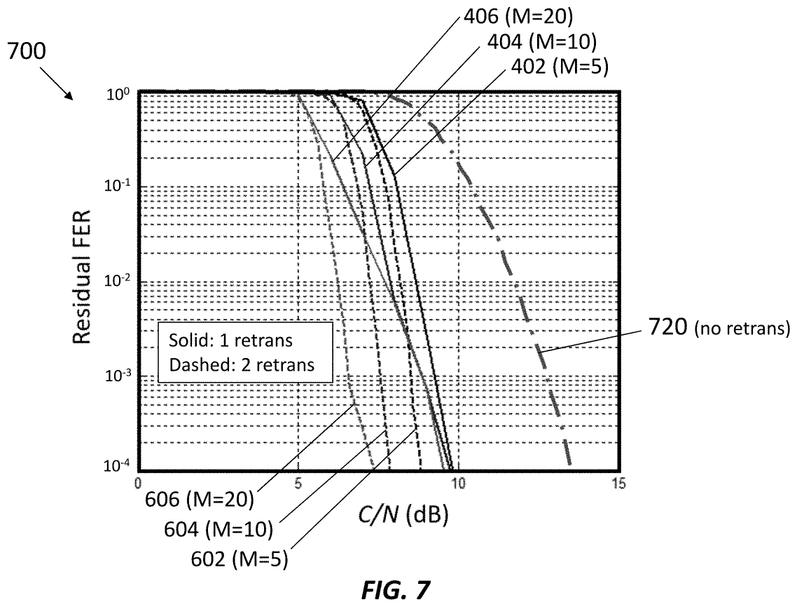

FIG. 7 illustrates a graph 700 indicating the example test data from the hierarchical packet analysis algorithm after one retransmission (i.e., curves 402, 404, 406 shown in FIG. 3) and after two retransmissions (i.e., curves 602, 604, 606 shown in FIG. 6). As shown, execution of the hierarchical packet analysis algorithm after two retransmissions provides significant improvement as compared with execution of the algorithm after one retransmission, for all values of M.

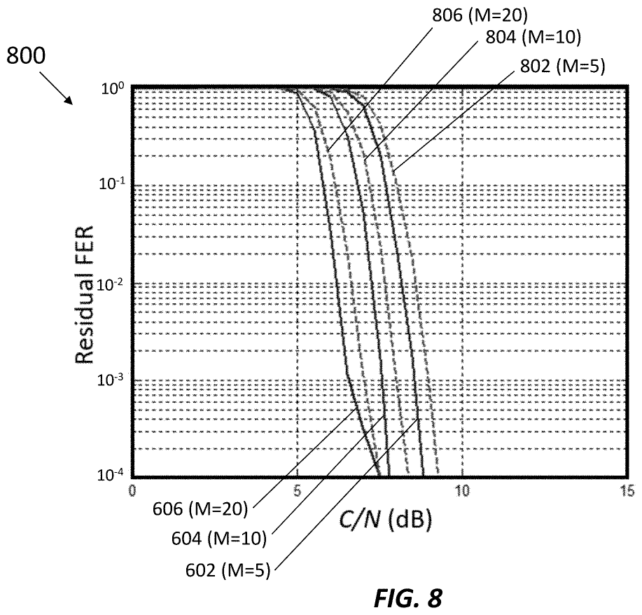

FIG. 8 illustrates a graph 800 showing (a) curves 602, 604, and 606 showing the example test data from the hierarchical packet analysis algorithm shown in FIG. 5 after two retransmissions, and (b) curves 802, 804, and 806 showing example test data from a reference smart retransmission scheme. In the known smart retransmission scheme, (curves 802, 804, and 806) all packet instances are analyzed collectively after each received packet retransmission; unlike the staged, hierarchical packet analysis algorithm disclosed herein, the known smart retransmission scheme does not involve a staged, hierarchical analysis. For example, after a second packet retransmission (providing a total of three packet instances at the receiving device), the reference smart retransmission scheme performs only a triplet analysis of the three packet instances, as opposed to performing a pair-wise analysis followed by (only if still necessary) a triplet analysis as in the disclosed algorithm. Thus, the reference smart retransmission scheme does not provide the opportunity to discover the true content of the transmitted packet via a pair-wise analysis and thereby avoid the more computationally-intensive triplet analysis.

As shown in FIG. 8, the hierarchical packet analysis algorithm disclosed herein provides improved performance (e.g., wireless range as represented by the C/N value for a defined residual FER value) as compared with the reference smart retransmission scheme.

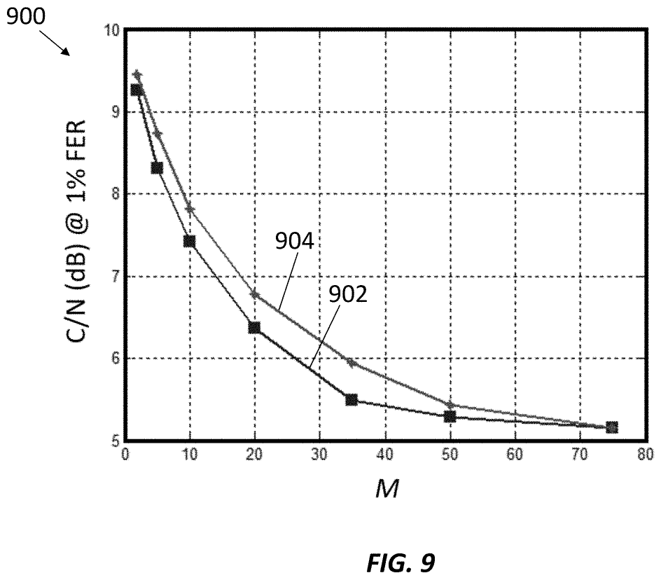

FIG. 9 illustrates a graph 900 showing data indicating carrier/noise ratio at 1% residual FER as a function of M value (maximum number of error bits) after two packet retransmissions, for (a) the hierarchical packet analysis algorithm disclosed herein, indicated by curve 902, and (b) the reference smart retransmission algorithm discussed above, indicated by curve 904. As show, as M approaches zero, the analysis approaches the case of dumb retransmission (i.e., no post-processing). As M approaches infinity, we approach the ideal case of no hardware/data processing limitations, and the results are the same for either approach. For lower values of M (i.e., representing real-world scenarios in which data processing is limited by relevant hardware restrictions), a lower C/N ratio is needed to achieve the target 1% FER using the disclosed hierarchical packet analysis algorithm, as opposed to the reference smart retransmission algorithm.

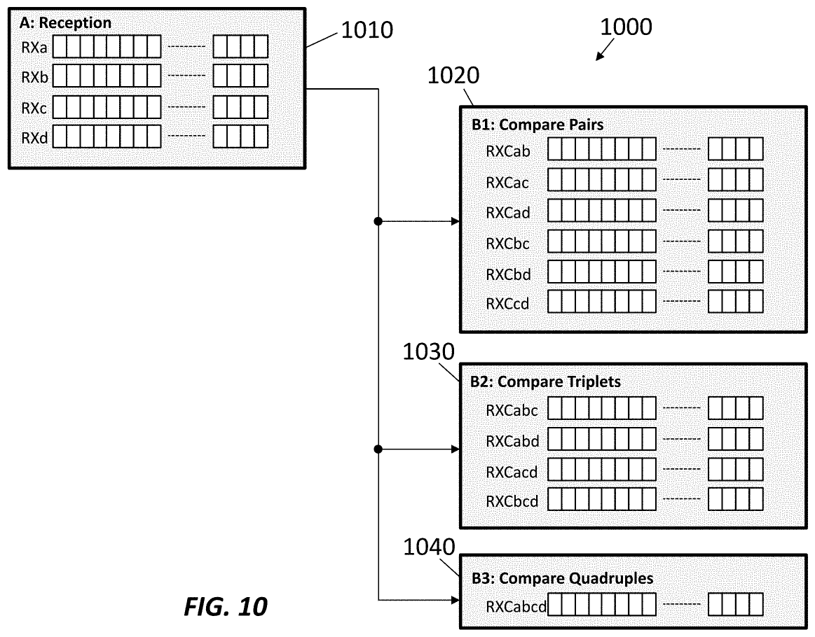

FIG. 10 illustrates an example execution of a hierarchical packet analysis algorithm 1000 after receiving a third retransmission of a failed packet, in a packet-based wireless communication system that uses a smart retransmission scheme allowing for three (or more) retransmissions, according to one embodiment of the invention. For example, FIG. 10 may represent a continuation of the algorithm shown in FIG. 5, in a situation in which the algorithm fails to discover the true content of the transmitted packet TX after two retransmissions, for example (a) due to the presence of at least one “triple error” occurring in the same bit position in packet instances RXa, RXb, and RXc, or (b) the number of testable error bit positions was capped according to the particular implementation and the correct test bit pattern (representing the true content of packet TX) was never tested due to the error bit position cap.

As shown, according to the hierarchical packet analysis algorithm, after receiving a third retransmission RXd of a failed packet TX, the receiving device has received a total of four received packet instances, RXa, RXb, RXc, and RXd, as indicated at 1010. The receiving device then analyzes the four packet instances in a staged, hierarchical manner. First, the receiving device performs a CRC check of RXd individually. If the CRC check of RXd fails, the receiving device performs a pair-wise packet analysis of the four packet instances RXa, RXb, RXc, and RXd, as indicted at 1020. As shown, the pair-wise packet analysis may define and analyze six different pairs of packet instances.

If the pair-wise packet analysis fails to discover the true content of packet TX, the receiving device performs a triplet packet analysis of the four packet instances RXa, RXb, RXc, and RXd, as indicated at 1030. The triplet packet analysis is analogous to the pair-wise packet analysis but involves defining and analyzing selected triplets of the four packet instances RXa, RXb, RXc, and RXd instead of selected pairs. As shown, the triplet packet analysis may define and analyze four different triplets of packet instances.

Finally, if the triplet packet analysis fails to discover the true content of packet TX, the receiving device may perform a quadruple analysis of all four packet instances RXa, RXb, RXc, and RXd collectively.

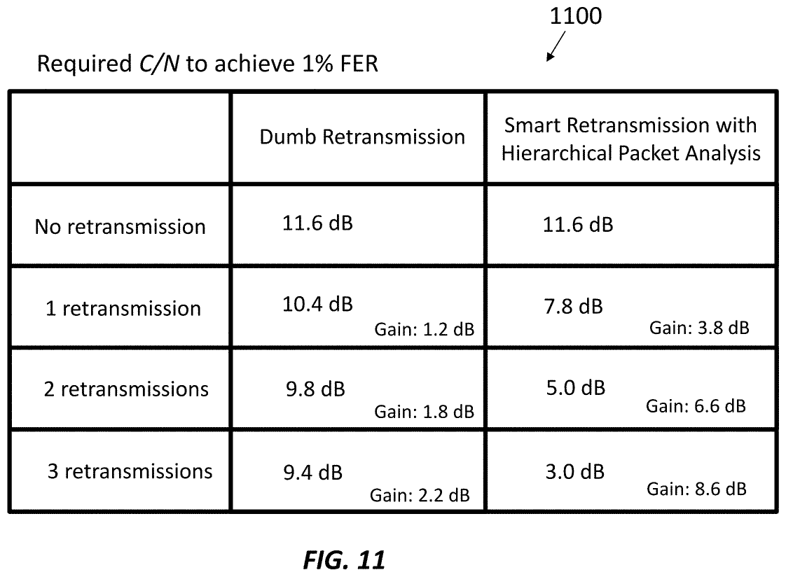

FIGS. 11-13 illustrates example test results of the hierarchical packet analysis algorithm executed by a receiving device, according to one embodiment of the present invention. FIG. 11 illustrates a table 1100 showing the required C/N to achieve 1% residual FER, for a protocol allowing no packet retransmissions, one retransmission, two retransmissions, and three retransmissions, using (a) a conventional dumb retransmission scheme and (b) the disclosed the hierarchical packet analysis algorithm. Table 1100 also shows the improvement in gain (in dB) for each respective solution as compared with the case of no retransmissions. As shown, using the hierarchical packet analysis algorithm in a protocol allowing up to three retransmissions provides a gain of 8.6 dB, which in practice increases the effectively wireless range by more than 100%.

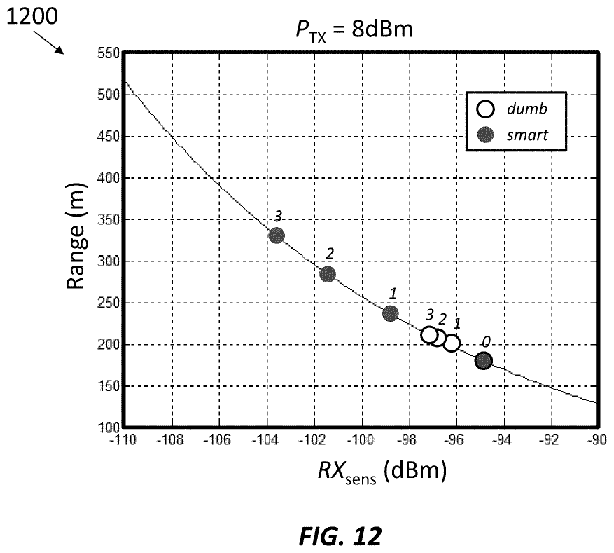

FIG. 12 illustrates a graph 1200 illustrating wireless range (in meters) as a function of receiver sensitivity (in dBm) for the different cases shown in table 11 of FIG. 11. As shown in graph 1200, the wireless range is significantly increased by the use of the hierarchical packet analysis algorithm, and additionally increased for each additional allowed retransmission.

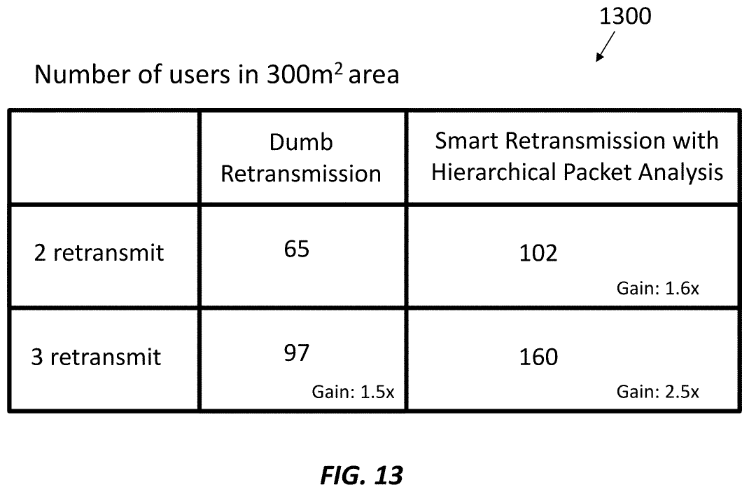

FIG. 13 illustrates a table 1300 showing the effect of the disclosed hierarchical packet analysis on user density in a reference Bluetooth Classic system co-existing with one WiFi hotspot and 100% loading on the 64 kb/s voice links. Because the proposed hierarchical smart retransmission scheme can reduce the need for additional retransmissions, the traffic on the wireless links reduces, thus reducing the probability of mutual collisions that result in packet errors. Furthermore, the hierarchical smart retransmission scheme results in a lower residual FER providing more wireless users with an acceptable link quality. This reduced traffic and reduced residual FER translate into an increase in overall user density. Table 1300 shows the number of users that can occupy an area of 300 m² experiencing a FER of 1% or less on the link in at least 95% of the cases. For a protocol allowing two retransmissions, the hierarchical packet analysis increases the allowable user density by a factor of 1.6 over a corresponding dumb retransmission scheme. For a protocol allowing three retransmissions, the hierarchical packet analysis increases the allowable user density by a factor of 2.5 over a corresponding dumb retransmission scheme.

FIG. 14 illustrates a majority voting algorithm 1400 for use with the disclosed hierarchical packet analysis algorithm, according to some embodiments of the invention. The majority voting algorithm 1400 may improve the efficiency of a collective analysis of three or more packet instances, e.g., a triplet packet analysis as performed in the algorithm execution shown in FIG. 5 or a quadruple packet analysis as performed in the algorithm execution shown in FIG. 10. The majority voting algorithm 1400 identifies the majority data value (1 or 0) present in each error bit position, and gives priority to the identified majority data values when generating and testing the different error bit combinations derivable from the set of error bit positions.

For example, FIG. 14 illustrates an example execution of the majority voting algorithm 1400 for performing a triplet packet analysis of example packet instances RXa, RXb, and RXc. As shown, a comparison of packet instances RXa, RXb, and RXc identifies three error bit positions: b6, b9, and b12. The majority data value is then determined for each error bit position. As indicated by the circling around selected values in bit positions b6, b9, and b12, the majority data values for b6, b9, and b12 are 1, 1, and 0, respectively. In this example, the majority data values (1, 1, 0) match the data values for the last-received packet instance, RXc; however, this is only coincidental.

The determined majority data values for error bit positions b6, b9, and b12 are then given priority for selecting an order in which the different error bit combinations are tested. As shown in the lower portion of FIG. 14, the three error bit positions b6, b9, and b12 define eight possible error bit combinations (2³=8), indicated at E0-E7. Each majority data value is shaded in each error bit combination E0-E7. According to the majority voting algorithm 1400, the eight error bit combinations E0-E7 are scheduled for testing based on the number of values matching the majority data values determined for b6, b9, and b12 1, 1, and 0). Thus, bit combination E6, which matches all three of the majority data values, is scheduled first.

Bit combinations E7, E4, and E2, which each match two of the three of majority data values, are scheduled next. The ordering between combinations E7, E4, and E2 may be determined according to any suitable rules. For example, the data contained in the last-received packet instance (here, RXc) may take priority over earlier received packet instances, or vice verse. As another example, majority data values present in consecutively-received packet instances (e.g., RXb and RXc) may take priority over majority data values present in non-consecutive packet instances (e.g., RXa and RXc).

Bit combinations E5, E3, and E0, each of which matches only one of the three of majority data values, are scheduled next. Finally, bit combination E1 (0, 0, 1), which consists of the minority data values for error bit positions b6, b9, and b12, is scheduled last.

In embodiments or instances in which the number of error bit combinations exceeds a maximum number of test bit patterns that may be tested (e.g., based on a maximum number of error bit positions M), the hierarchical packet analysis algorithm may select only a subset of the error bit combinations, as ranked by the majority voting algorithm 1400.

The majority voting algorithm 1400 may result in earlier discoveries of the true packet content (i.e., by a passed CRC check) in comparison with other protocols for ordering the various error bit combinations to be tested. Thus, majority voting algorithm 1400 may further improve the efficiency and performance of the disclosed hierarchical packet analysis algorithm, according to some embodiments.

FIG. 15 illustrates an example method 1500 for performing a hierarchical packet analysis for identifying the true content of a transmitted packet TX, according to some embodiments of the invention. At 1502, a receiving device receives from a transmitting device a first transmission of a packet TX, received as a first packet instance RXa. At 1504, the receiving device performs a CRC check on RXa. If the CRC check passes the true content of packet TX is identified, as indicated at 1506. If the CRC check fails the method proceeds to 1508, at which the receiving device requests and receives from the transmitting device a first retransmission of packet TX, received as a second packet instance RXb.

At 1510, the receiving device performs a CRC check on RXb. If the CRC check passes the true content of packet TX is identified, as indicated at 1512. If the CRC check fails, the method proceeds to 1514 for a pair-wise analysis of packet instances RXa and RXb. In particular, at 1514 the receiving device creates a packet pair RXCab, and identifies error bit positions in RXCab (i.e., bit positions in which RXa and RXb contain differing data). At 1516, the receiving device then generates a set of pair-wise test bit patterns derived from the identified error bit positions in RXCab, and performs a CRC check on each test bit pattern at 1518. If the CRC check passes the true content of packet TX is identified, as indicated at 1520. If the CRC check fails the method proceeds to 1522, at which the receiving device requests and receives from the transmitting device a second retransmission of packet TX, received as a second packet instance RXc.

Next, at 1524, the receiving device creates a packet pair RXCac from packet instances RXa and RXc, and a packet pair RXCbc from packet instances RXb and RXc, and identifies error bit positions in each of RXCac and RXCbc. The receiving device may then perform pair-wise analyses of packet pairs RXCac and RXCbc. In one embodiment, the receiving device may start with the packet pair RXCac or RXCbc having the fewest number of error bit positions, in this example RXCac.

At 1526, the receiving device generates a set of pair-wise test bit patterns derived from the identified error bit positions in RXCac, and performs a CRC check on each test bit pattern at 1528. If the CRC check passes the true content of packet TX is identified, as indicated at 1530. If the CRC check fails the method proceeds to 1532 to analyze the next packet pair, RXCbc. At 1532, the receiving device generates a set of pair-wise test bit patterns derived from the identified error bit positions in RXCbc, and performs a CRC check on each test bit pattern at 1534. If the CRC check passes the true content of packet TX is identified, as indicated at 1536. If the CRC check fails the method proceeds to 1538 to perform a triplet analysis of RXa, RXb, and RXc collectively.

At 1538, the receiving device creates a packet triplet RXCabc from packet instances RXa, RXb, and RXc, and identifies error bit positions in RXCabc. At 1540, the receiving device generates a set of triplet test bit patterns derived from the identified error bit positions in RXCabc, and performs a CRC check on each triplet test bit pattern at 1542. If the CRC check passes the true content of packet TX is identified, as indicated at 1544. If the CRC check fails the receiving device may declare a failed packet at 1546, and await the next packet from the transmitting device.

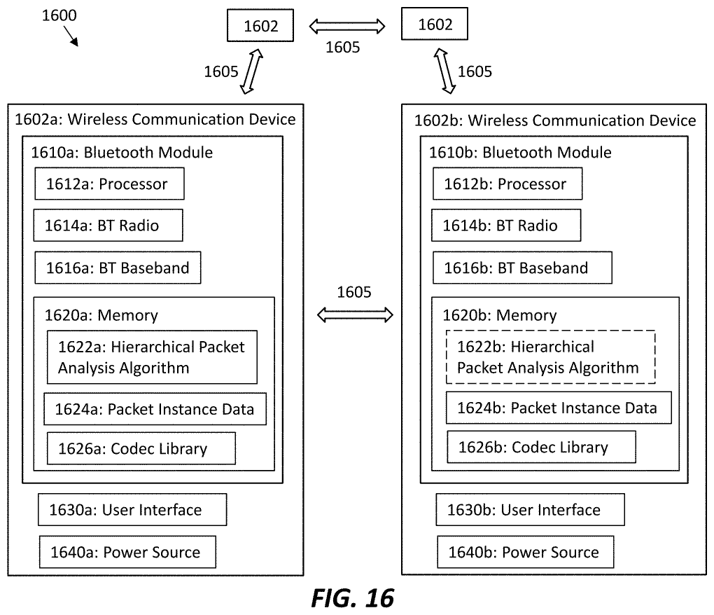

FIG. 16 illustrates an example system 1600 for performing a hierarchical packet analysis for identifying the true content of a transmitted packet, according to some embodiments of the invention. System 1600 includes a plurality of wireless communication devices 1602, including at least a first wireless communication device 1602a and a second wireless communication device 1602b, configured to communicate with each other using at least one wireless packet-based communications protocol that implements a packet retransmission scheme, e.g., Bluetooth, Bluetooth Classic, Bluetooth derivatives such as Bluetooth Low Energy (BLE), or Digital European Cordless Telecommunications (DECT) protocols. In some embodiments, system 1600 may include multiple wireless communication devices 1602 located within a common physical environment, for example a telephone call center or an office environment having a high density of users.

Each wireless communication device 1602, including devices 1602a and 1602b, may be configured for wireless communications with any one, some, or all other wireless communication devices 1602 in the relevant physical environment. In some embodiments, each wireless communication device 1602, including device 1602a and/or device 1602b, may be configured to operate as a wireless base station or a wireless client device (or both) with respect to one or more other wireless communication device 1602.

Each wireless communication device 1602, including devices 1602a and 1602b, may comprise any type of device configured for wireless communications as described above, e.g., a mobile phone (e.g., smart phone), headset, PDA, laptop or other portable computer, desktop computer or terminal, or other electronic device.

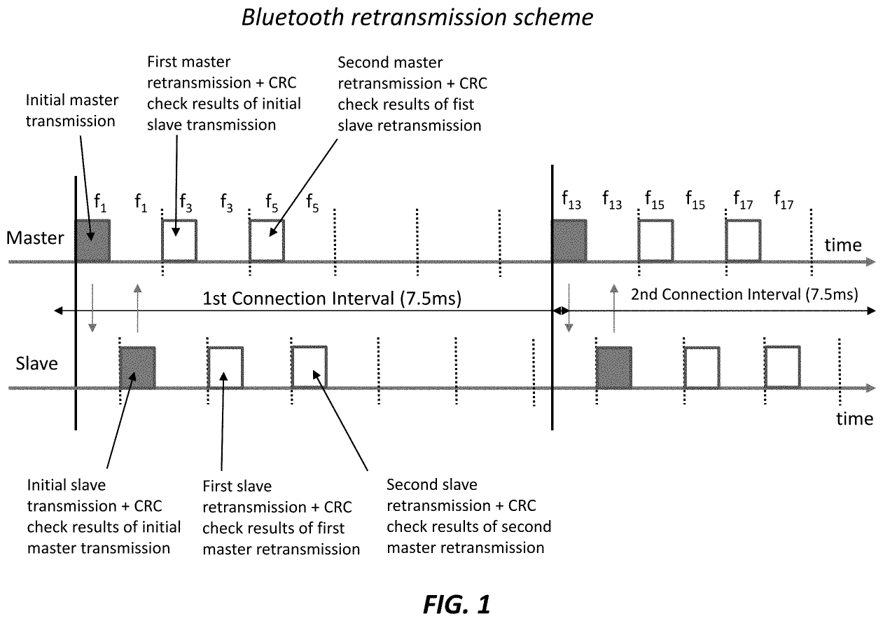

In the illustrated example, communication devices 1602a and 1602b are configured for Bluetooth communications with each other via a Bluetooth link 1605. Each devices 1602a and 1602b is configured to implement a Bluetooth communication protocol, including a packet retransmission scheme (e.g., as shown in FIG. 1 discussed above), and further configured to implement a hierarchical packet analysis algorithm as disclosed herein to determine the true content of packets received from the other device 1602b, 1602a with erroneous data/bits (“failed packets”). With reference to the Bluetooth retransmission scheme shown in FIG. 1, either device 1602a or 1602b may act as a master device and the other as a slave, in any particular instance. In other embodiments, one device 1602a or 1602b may be configured to act only as a master and the other only as a slave.

As shown in FIG. 16, the first wireless communication device 1602a may include (among other components) a Bluetooth module 1610a, a user interface 1630a, and a power source 1640a. Bluetooth module 1610a may include a processor 1612a, Bluetooth radio 1614a, and Bluetooth baseband 1616a. Bluetooth module 1610a may also include memory 1620a storing a hierarchical packet analysis algorithm 1622a, packet instance data 1624a, and a Codec library 1626a. Hierarchical packet analysis algorithm 1622a is executable by processor 1612a to perform any of the functionality described herein, e.g., the example algorithm shown in FIG. 15.

Codec library 1626a includes codecs available for selection and use by device 1602a. In a Bluetooth implementation, available codecs may include, for example: (a) CVSD (64 kb/s), (b) mSBC (64 kb/s), and (c) mSBC (128 kb/s). New codecs may be included like CELT or LC3. In a Bluetooth implementation, packet types include HV1-HV3, EV3-EV5, 2-EV3, 2-EV5, 3-EV3, and 3-EV5. In an alternative DECT implementation, available codecs may include, for example: (a) G726 (32 kb/s) and (b) G722 (64 kb/s).

Processor 1612a executes programs or code stored in memory 1620a, including hierarchical packet analysis algorithm 1622a as noted above. Bluetooth radio 1614a may include an antenna port, and may be implemented on a separate chip. Bluetooth radio 1614a may include a Bluetooth compatible transmitter modulator and a Bluetooth compatible receiver modulator. Bluetooth radio 1614a is configured to transmit or receive voice or data packets via an antenna. Bluetooth radio 1614a may be a dual-mode radio communicating to the client device using the Bluetooth Classic standard and communicating to the central controller using the Bluetooth Low Energy (Long Range) standard.

Processor 1612a may include a variety of processors (e.g., digital signal processors), with conventional CPUs being applicable. Memory 1620a may include a variety of memories, and in one example includes RAM, ROM, flash memory, or a combination thereof. Memory 1620a may further include separate memory structures or a single integrated memory structure.

As shown, the second wireless communication device 1602b may include (among other components) similar components as the first wireless communication device 1602a, wherein like components are indicated by the same reference number, but substituting suffix “a” with suffix “b.” Alternatively, second wireless communication device 1602b may not be configured for hierarchical packet analysis; thus, an optional hierarchical packet analysis algorithm 1622b is indicated with dashed lines. An implementation in which device 1602a but not 1602b is configured for hierarchical packet analysis may result in an imbalance in the link budget (thus range), as device 1602a may have better receiver sensitivity performance than device 1602b. In some embodiments, system 1600 may be configured to reduce or correct this imbalance in multiple different ways. For example, device 1602a may use a higher transmit power, or devices 1602a and 1602b devices may use a more robust modulation and/or encoding scheme for communications between the devices.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A method for identifying a true content of a transmitted data packet wirelessly transmitted by a first device to a second device, the method comprising:
receiving, at the second device, a first packet instance comprising a received version of the transmitted data packet;
receiving, at the second device, a second packet instance comprising a received version of a first retransmission of the data packet transmitted by the first device;
receiving, at the second device, a third packet instance comprising a received version of a second retransmission of the data packet transmitted by the first device;
wherein the first, second, and third packet instances received at the second device define a packet instance group, and wherein each packet instance in the packet instance group includes erroneous data differing from the true content in at least one bit position;
executing a hierarchical packet analysis algorithm to attempt to determine the true content of the transmitted data packet, the hierarchical packet analysis including:
(a) analyzing pairs of packet instances selected from the packet instance group to attempt to determine the true content of the transmitted data packet; and
(b) if the analysis of the pairs of packet instances fails to determine the true content of the transmitted data packet, analyzing the first, second, and third packet instances collectively to attempt to determine the true content of the transmitted data packet.

2. The method of claim 1, wherein analyzing pairs of packet instances selected from the packet instance group to attempt to determine the true content of the transmitted data packet comprises:
selecting and analyzing a pair of packet instances to attempt to determine the true content of the transmitted data packet; and
repeating the selecting and analyzing step for each pair of packet instances in the packet instance group until either (a) the true content of the transmitted data packet is determined or (b) all pairs of packet instances in the packet instance group have been analyzed.

3. The method of claim 2, wherein the step of selecting and analyzing a pair of packet instances to attempt to determine the true content of the transmitted data packet comprises:
comparing the selected pair of packet instances to identify a set of error bit positions in which the selected pair of packet instances include different data from each other;
generating a set of test bit patterns based on the set of error bit positions identified from the comparison of the selected pair of packet instances; and
analyzing each test bit pattern to determine whether the test bit pattern contains the true content of the transmitted data packet.

4. The method of claim 3, wherein the step of generating a set of test bit patterns comprises:
identifying a set of bit value combinations for the set of error bit positions identified from the comparison of the selected pair of packet instances; and
generating a test bit pattern for each identified bit value combination.

5. The method of claim 3, comprising:
defining a maximum number of error bit positions to be analyzed; and
wherein generating a set of test bit patterns based on the set of error bit positions comprises generating a limited number of test bit patterns defined by the defined maximum number of error bit positions to be analyzed.

6. The method of claim 3, comprising:
determining a number of error bit positions in each pair of packet instances; and
determining an order to analyze the pairs of packet instances based on the number of error bit positions in each pair of packet instances.

7. The method of claim 3, wherein analyzing each test bit pattern to determine whether the test bit pattern contains the true content of the transmitted data packet comprises performing a Cyclic Redundancy Check (CRC) on each test bit pattern.

8. The method of claim 1, wherein the step of analyzing the first, second, and third packet instances collectively to attempt to determine the true content of the transmitted data packet comprises:
comparing the first, second, and third packet instances collectively to identify a set of error bit positions in which at least two of the packet instances include different data from each other;
generating a set of test bit patterns based on the set of error bit positions identified from the collective comparison of the first, second, and third packet instances; and
analyzing each test bit pattern to determine whether the test bit pattern contains the true content of the transmitted data packet.

9. The method of claim 8, wherein the step of generating a set of test bit patterns comprises:
identifying a set of bit value combinations for the set of error bit positions identified from the collective comparison of the first, second, and third packet instances; and
generating a test bit pattern for each identified bit value combination.

10. The method of claim 8, comprising:
for each error bit position in the set of error bit positions, determining a majority value contained in a majority of the packet instances;
for each test bit pattern in the set of test bit patterns, determining a number of bit positions containing the majority value for that respective bit position; and
ordering the test bit patterns in the set of test bit patterns based on the number of bit positions containing the majority value.

11. The method of claim 1, further comprising, after receiving the first packet instance at the second device:
determining, by the second device, that the received first packet instance contains erroneous data; and
transmitting, from the second device to the first device, a notification that the received first packet instance contains erroneous data.

12. The method of claim 11, wherein determining that the received first packet instance contains erroneous data comprises performing a Cyclic Redundancy Check (CRC).

13. The method of claim 1, wherein the data packet is transmitted and retransmitted according to Bluetooth protocol.

14. The method of claim 1, wherein the first, second, and third packet instances are received at the second device via a Bluetooth link or a Digital Enhanced Cordless Telecommunications (DECT) link.

15. A system for identifying a true content of a transmitted data packet transmitted by a first device to a second device, the system comprising:
a hierarchical packet analysis algorithm stored in non-transitory computer readable memory; and
a computer processor coupled to the non-transitory computer readable memory and configured to:
receive a first packet instance comprising a received version of the transmitted data packet;
receive a second packet instance comprising a received version of a first retransmission of the data packet transmitted by the first device;
receive a third packet instance comprising a received version of a second retransmission of the data packet transmitted by the first device;
wherein the first, second, and third packet instances received at the computer processor define a packet instance group, and wherein each packet instance in the packet instance group includes erroneous data differing from the true content in at least one bit position;
execute the hierarchical packet analysis stored in the non-transitory computer-readable memory to determine the true content of the transmitted data packet, wherein executing the hierarchical packet analysis comprises:
(a) analyzing pairs of packet instances selected from the packet instance group to attempt to determine the true content of the transmitted data packet; and
(b) if the analysis of the pairs of packet instances fails to determine the true content of the transmitted data packet, analyzing the first, second, and third packet instances collectively to attempt to determine the true content of the transmitted data packet.

16. A system, the system comprising:
a first device configured to wirelessly transmit and retransmit a data packet for receipt by a second device; and
a second device configured to:
receive a first packet instance comprising a received version of an original transmission of the data packet by the first device;
notify the first device that the first packet instance includes erroneous data;
receive a second packet instance comprising a received version of a first retransmission of the data packet by the first device;
notify the first device that the second packet instance includes erroneous data;
receive a third packet instance comprising a received version of a second retransmission of the data packet by the first device;
wherein the first, second, and third packet instances received at the second device define a packet instance group, and wherein each packet instance in the packet instance group includes erroneous data differing from a true content of the data packet in at least one bit position;
execute a hierarchical packet analysis to determine the true content of the data packet, wherein executing the hierarchical packet analysis comprises:
(a) analyzing pairs of packet instances selected from the packet instance group to attempt to determine the true content of the data packet; and
(b) if the analysis of the pairs of packet instances fails to determine the true content of the data packet, analyzing the first, second, and third packet instances collectively to attempt to determine the true content of the data packet.
